(19) United States
(12) Patent Application Publication
(10) Pub. No.: US 2008/0111769 A1
(43) Pub. Date: May 15, 2008

(54) Plasma display device

(76) Inventors: Won-Kyu Bang, Suwon-si (KR); Myoung-Kon Kim, Suwon-si (KR)

Correspondence Address: Robert E. Bushnell, Suite 300, 1522 K Street, N.W., Washington, DC, 20005, US

(21) Appl. No.: 11/797,765

(22) Filed: May 7, 2007

(30) Foreign Application Priority Data
Nov. 15, 2006 (KR) 10-2006-0113060
Nov. 20, 2006 (KR) 10-2006-0114709

(51) Int. Cl. G09G 3/28

(52) U.S. Cl. 345/60

(57) ABSTRACT

Provided is a plasma display device that can uniformly dissipate heat of an electronic device of a signal transmitter and prevent the electronic device from being damaged. The plasma display device includes a Plasma Display Panel (PDP) that displays an image; a chassis base disposed on the rear of the PDP; a drive circuit included in the chassis base generating an electrical signal to drive the PDP; a plurality of signal transmission members including a plurality of electronic devices such that one end of each signal transmission member is connected with the drive circuit and the other end of each signal transmission member is connected with the PDP in order for a signal that is generated from the drive circuit to be transmitted to the PDP; a covering member covering the electronic devices; and a plurality of supporting member which tightens the covering member to the chassis base and spaces the covering member and the chassis base apart from each other by a predetermined interval.

### CLAIM OF PRIORITY

This application makes reference to, incorporates the same herein, and claims all benefits accruing under 35 U.S.C. § 119 from applications for PLASMA DISPLAY DEVICE earlier filed in the Korean Intellectual Property Office on 15 Nov. 2006 and there duly assigned Serial No. 10-2006-0113060 and Serial No. 10-2006-0114709 filed on 20 Nov. 2006.

### BACKGROUND OF THE INVENTION

1. Field of the Invention

The present invention relates to a plasma display device, and more particularly, the present invention relates to a plasma display device having improved heat dissipation efficiency.

2. Description of the Related Art

Plasma display devices using Plasma Display Panels (PDPs) are flat display devices that display images using a gas discharge, and are considered to be the next generation large-scale flat panel display devices due to excellent display properties, such as high brightness, high contrast, lack of a residual image, a wide viewing angle, and a thin and large-scale display structure.

In general, a plasma display device includes a Plasma Display Panel (PDP), a chassis base to support the PDP, a driver circuit to drive the PDP, and a case.

The plasma display device further includes a signal transmitter in which electronic devices are mounted to mediate signal transmission between the PDP and the driver circuit of the PDP.

The electronic devices generate a driving signal for the PDP and when the PDP is operated, a large amount of heat is generated. In this case, the generated heat causes deterioration of the electronic devices and thus, the plasma display device cannot be smoothly operated.

Accordingly, heat generated by the electronic devices is transmitted to the chassis base or a supporting member installed on a rear surface of the chassis base so as to dissipate the heat to the outside. In addition, a covering member is installed so that heat generated by the electronic devices is transmitted to the covering member and thus, heat is dissipated to the outside. Furthermore, a heat conductive sheet is interposed between the electronic devices and the covering member.

However, if more than a certain amount of power is supplied to the PDP from the outside, the signal transmitter may be damaged or disconnected from the chassis base or the supporting member, thereby lowering the heat dissipation efficiency of the PDP.

Moreover, in order for the plasma display device to be slim, the electronic devices are smaller and an address scanning is installed in a single scanning structure, thereby placing the electronic devices at the lower part of the chassis base. In this case, if the electronic devices, in particular, a slim Tape Carrier Package (TCP), is fixed onto the rear surface of the chassis base, the covering member may be inclined and an Integrated Circuit (IC) that is mounted on the slim TCP may be damaged.

### SUMMARY OF THE INVENTION

The present invention provides a plasma display device, which can uniformly dissipate heat with respect to electronic devices of a signal transmitter and can prevent the electronic devices from being damaged.

According to an aspect of the present invention, a plasma display device is provided including: a Plasma Display Panel (PDP) to display an image; a chassis base arranged on the rear of the PDP; a drive circuit affixed to the chassis base, the drive circuit generating an electrical signal to drive the PDP; a plurality of signal transmission members having first and second ends and including a plurality of electronic devices, the first end of each signal transmission member being connected to the drive circuit and the second end of each signal transmission member being connected to the PDP to transmit a signal generated by the drive circuit to the PDP; a covering member to cover the electronic devices of the signal transmission members; and a plurality of supporting members to affix the covering member to the chassis base and to space the covering member apart from the chassis base by a predetermined interval.

The interval between the covering member and the chassis base preferably corresponds to a thickness of the signal transmission members including the electronic devices.

Each of the supporting members preferably includes a first supporter arranged between the covering member and the chassis base, the first supporter spacing the covering member apart from the chassis base. Each of the supporting members preferably includes a second supporter to prevent the supporting members from separating from the chassis base. Each of the supporting members preferably includes a head on an end thereof to support the covering member.

The supporting members are preferably arranged between the electronic devices. The supporting members preferably include a metal. The supporting members are preferably plated. The supporting members alternately preferably include a synthetic resin.

The chassis base preferably includes a bending unit on an edge thereof, the electronic devices being arranged to correspond to the bending unit, and the supporting members being affixed to the bending unit.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a plasma display device according to an embodiment of the present invention;

FIG. 2 is an enlarged cross-sectional view of the plasma display device taken along line II-II of FIG. 1, according to an embodiment of the present invention;

FIG. 3 is an enlarged perspective view of a supporting member of the plasma display device of FIGS. 1 and 2, according to an embodiment of the present invention; and

FIG. 4 is a cross-sectional view of a plasma display device according to another embodiment of the present invention.

### DETAILED DESCRIPTION OF THE INVENTION

Hereinafter, the present invention is described more fully with reference to the accompanying drawings, in which exemplary embodiments of the present invention are shown.

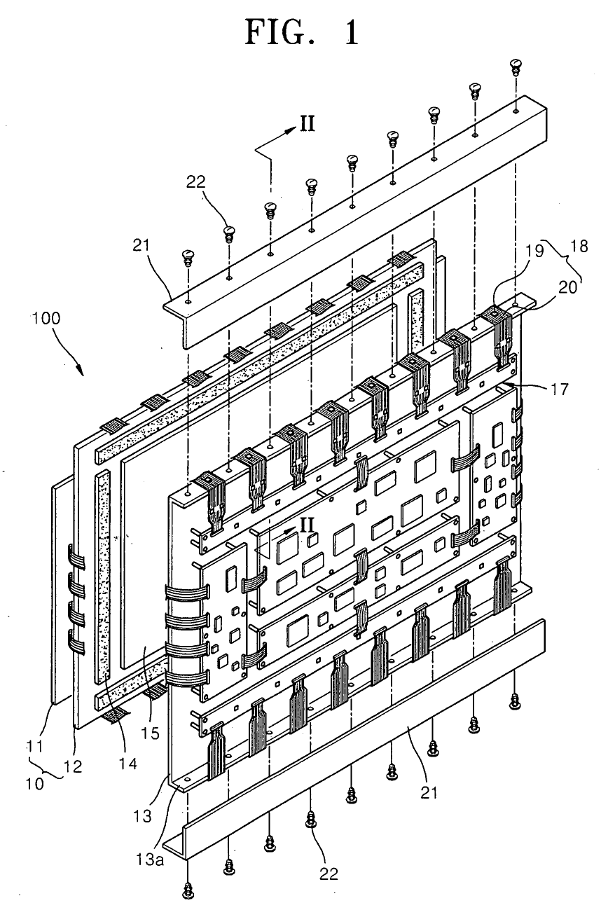

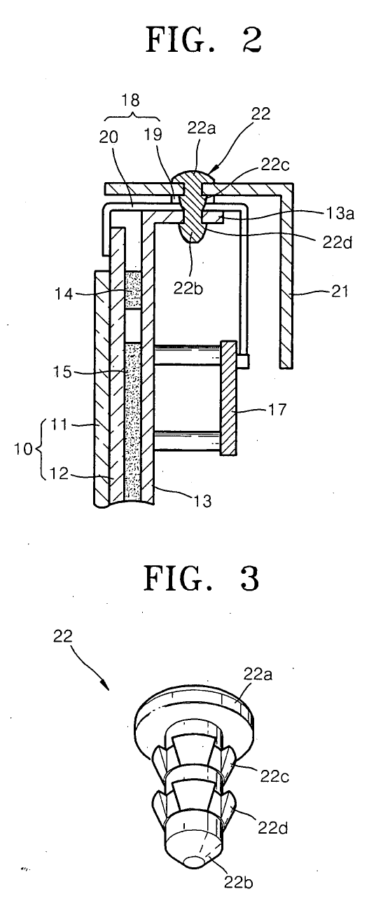

FIG. 1 is an exploded perspective view of a plasma display device 100 according to an embodiment of the present invention, FIG. 2 is an enlarged cross-sectional view of the plasma display device 100 taken along line II-II of FIG. 1, according to an embodiment of the present invention, and FIG. 3 is an enlarged perspective view of one of a plurality of supporting members 22 of the plasma display device 100 of FIGS. 1 and 2, according to an embodiment of the present invention.

The plasma display device 100 illustrated in FIGS. 1 and 2 according to an embodiment of the present invention includes a Plasma Display Panel (PDP) 10, a chassis base 13, and driver circuits 17.

The PDP 10 displays an image and includes a front panel 11 and a rear panel 12, wherein the front panel 11 and the rear panel 12 face each other and are joined together. The PDP 10 may be selected from various kinds of PDPs, for example, a three electrode surface discharge Alternating Current (AC) PDP. The front panel 11 and the rear panel 12 include a substrate, a plurality of electrodes disposed on the substrate such that a voltage is supplied to the electrodes, and a dielectric layer covering the electrodes.

At the rear of the PDP 10, the chassis base 13 is installed to support the PDP 10 and is affixed to the PDP 10 by using an adhesive 14, such as double-sided tape or a bonding agent. In the present embodiment, the adhesive 14 is disposed along the edge of the chassis base 13.

In addition, the chassis base 13 receives heat generated by the PDP 10 and smoothly dissipates the heat to the outside. Accordingly, the chassis base 13 may be formed of a material having excellent heat radiation properties, such as aluminum. However, in order to reduce the weight and manufacturing costs of the chassis base 13, the chassis base 13 may be formed of a synthetic resin and may be manufactured by casting or pressing. The chassis base 13 may have a bending unit 13a that is bent in an opposite direction away from the PDP 10 and disposed on the upper and lower parts of the chassis base 13.

A heat transmitter 15, such as a heat conductive sheet may be interposed between the PDP 10 and the chassis base 13. The heat transmitter 15 partially dissipates heat generated by the PDP 10 during the driving of the plasma display device 100. In addition, the heat transmitter 15 smoothly transmit heat generated by the PDP 10 to the chassis base 13 and thus, the heat can be easily dissipated to the outside. As illustrated in FIG. 2, the heat transmitter 15 can be closely affixed to the PDP 10 and the chassis base 13. However, the present invention is not limited thereto. Hence, a surface of the heat transmitter 15 may contact the PDP 10 and another surface of the heat transmitter 15 may be disposed apart from the chassis base 13 and the heat transmitter 15 may be formed of graphite or silicon.

Although not illustrated in the drawings, the bending unit 13a of the chassis base 13 may include a supporting member (not illustrated) thereon in order to prevent the chassis base 13 from bending and twisting and may be formed of aluminum.

At the rear of the chassis base 13, the drive circuits 17 are installed. The drive circuits 17 generate an electrical signal, which drives the PDP 10, and transmits the electrical signal to the PDP 10.

A plurality of signal transmission members 18 are interposed between the drive circuits 17 and the PDP 10 to connect the drive circuits 17 to the PDP 10. The signal transmission members 18 mediate an electrical signal transmission between the drive circuits 17 and the PDP 10 and may be Tape Carrier Packages (TCPs) or Chips on Films (COFs).

The signal transmission members 18 include a plurality of electronic devices 19, such as Integrated Circuits (ICs), which control the signal transmission between the drive circuits 17 and the. PDP 10.

Each signal transmission member 18 is formed of an electronic device 19, such as an IC, and a wiring unit 20 that is in a tape form. When the signal transmission members 18 are used to connect the drive circuits 17 to the PDP 10, the electronic devices 19 maybe arranged to correspond to the bending unit 3 la that is formed on the edge of the upper and lower parts of the chassis base 13. Accordingly, the plasma display device 100 can be as slim as the thickness of the electronic devices 19.

A covering member 21 is installed on the lower part of the rear of the chassis base 13 to cover the signal transmission members 18 on which the electronic devices 19 are mounted, in particular, to cover the electronic devices 19 of the signal transmission members 18.

The covering member 21 smoothly dissipates heat generated by the signal transmission members 18 including the electronic devices 19 and obstructs power supplied to the PDP 100 from the outside so as to prevent damage to the signal transmission members 18. Furthermore, since the covering member 21 covers the electronic devices 19, noise generated from the electronic devices 19 can be blocked. The covering member 21 can be manufactured using various kinds of materials and may be formed of aluminum, which has excellent heat conductivity and rigidity. The covering member 21 may be affixed to the chassis base 13, in particular, affixed to the bending unit 13a of the chassis base 13, by the supporting members 22 as described later.

In FIG. 1, one end of each of the signal transmission members 18 is connected to the upper and lower parts of the PDP 10. However, the present invention is not limited thereto. In a single scanning process, the signal transmission members 18 may be connected to any side of the upper and lower parts of the PDP 10.

When the PDP 10 is operated, heat travels concentrically from the signal transmission members 18, in particular, from the electronic devices 19. In the present embodiment, a portion of the heat generated by the electronic devices 19 is conducted to the covering member 21 and the remainder of the heat generated by the electronic devices 19 is conducted to the chassis base 13 in order to be dissipated to the outside.

In order to easily conduct heat generated by the electronic devices 19 to the covering member 21, a heat conductive sheet (not illustrated) may be interposed between the signal transmission members 18 and the covering member 21.

In addition, as illustrated in FIG. 2, the supporting members 22 space the covering member 21 and the chassis base 13 apart from each other by a predetermined interval. The distance of the interval may correspond to the thickness of the signal transmission members 18. In other words, the distance of the interval between the covering member 21 and the chassis base 13 in FIG. 2 may be the same as the total sum of the thicknesses of an electronic device 19 and a wiring unit 20. Therefore, since the covering member 21 contacts the electronic devices 19, the heat dissipation property of the electronic devices 19 increases. In addition, when the covering member 21 contacts the electronic devices 19, excessive pressure is not applied to the electronic devices 19 and thus, the electronic devices 19 may not be damaged.

Each supporting member 22 includes a first supporter 22c to space the covering member 21 apart from the chassis base 13.

FIG. 3 is an enlarged perspective view of one of the supporting members 22, according to an embodiment of the present invention.

As illustrated in FIG. 3, the supporting member 22 includes a head 22a and a body 22b. The body 22b extends in a straight line from the head 22a and penetrates the covering member 21 and the chassis base 13. Hence, the head 22a of the supporting member 22 supports the covering member 21.

At the side of the body 22b, a double-layered wedge-shaped projection is formed. A first supporter 22c is disposed near the head 22a and a second supporter 22d is disposed farther from the head 22a than the first supporter 22c. The first and second supporters 22c and 22d are interposed between the covering member 21 and the chassis base 13 and cannot be removed once inserted.

As illustrated in FIG. 2, the distance of the interval between the covering member 21 and the chassis base 13 can be uniformly maintained due to the first supporter 22c. In addition, the supporting member 22 is disposed in order for the second supporter 22d not to be caught with the chassis base 13.

In the present invention, the chassis base 13 and the covering member 21 are fixed due to the supporting member 22 and thus, the covering member 21 can uniformly support the electronic devices 19. Therefore, when the covering member 21 is tightened with bolts and is inclined, the electronic devices 19 can be prevented from being damaged.

The supporting member 22 may be formed of metal so that heat conduction between the chassis base 13 and covering member 21 is improved. In addition, the surface of the supporting member 22 maybe plated with copper so that heat conduction is improved. However, the supporting member 22 is not limited thereto and the supporting member 22 can be formed of a synthetic resin.

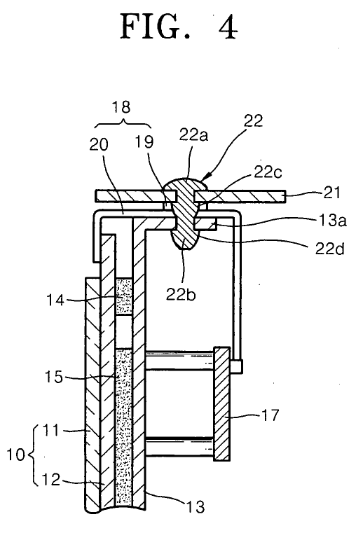

The covering member 21 may be any shape as long as the covering member 21 can cover the electronic devices 19. As illustrated in FIG. 4, the covering member 21 may be a shape to cover the portion corresponding to the electronic devices 19.

As described above, in a plasma display device according to the present invention, a covering member which covers a signal transmission member stably attaches to a chassis base and thus the signal transmission member, in particular, electronic devices, can be prevented from being damaged.

In addition, since the covering member is uniformly affixed to the signal transmission member, in particular, uniformly affixed to the electronic devices, heat is uniformly dissipated from the PDP.

While the present invention has been particularly shown and described with reference to exemplary embodiments thereof, it will be understood by one of ordinary skill in the art that various modifications in form and detail may be made therein without departing from the spirit and scope of the present invention as defined by the following claims.

What is claimed is:

1. A plasma display device comprising:
a Plasma Display Panel (PDP) to display an image;
a chassis base arranged on the rear of the PDP;
a drive circuit affixed to the chassis base, the drive circuit generating an electrical signal to drive the PDP;
a plurality of signal transmission members having first and second ends and including a plurality of electronic devices, the first end of each signal transmission member being connected to the drive circuit and the second end of each signal transmission member being connected to the PDP to transmit a signal generated by the drive circuit to the PDP;
a covering member to cover the electronic devices of the signal transmission members; and
a plurality of supporting members to affix the covering member to the chassis base and to space the covering member apart from the chassis base by a predetermined interval.

2. The device of claim 1, wherein the interval between the covering member and the chassis base corresponds to a thickness of the signal transmission members including the electronic devices.

3. The device of claim 1, wherein each of the supporting members comprises a first supporter arranged between the covering member and the chassis base, the first supporter spacing the covering member apart from the chassis base.

4. The device of claim 1, wherein each of the supporting members comprises a second supporter to prevent the supporting members from separating from the chassis base.

5. The device of claim 4, wherein each of the supporting members comprises a head on an end thereof to support the covering member.

6. The device of claim 1, wherein the supporting members are arranged between the electronic devices.

7. The device of claim 1, wherein the supporting members comprise a metal.

8. The device of claim 7, wherein the supporting members are plated.

9. The device of claim 1, wherein the supporting members comprise a synthetic resin.

10. The device of claim 1, wherein the chassis base comprises a bending unit on an edge thereof, the electronic devices being arranged to correspond to the bending unit, and the supporting members being affixed to the bending unit.

11. The device of claim 2, wherein the chassis base comprises a bending unit on an edge thereof, the electronic devices being arranged to correspond to the bending unit, and the supporting members being affixed to the bending unit.

12. The device of claim 3, wherein the chassis base comprises a bending unit on an edge thereof, the electronic devices being arranged to correspond to the bending unit, and the supporting members being affixed to the bending unit.

13. The device of claim 4, wherein the chassis base comprises a bending unit on an edge thereof, the electronic devices being arranged to correspond to the bending unit, and the supporting members being affixed to the bending unit.

14. The device of claim 5, wherein the chassis base comprises a bending unit on an edge thereof, the electronic devices being arranged to correspond to the bending unit, and the supporting members being affixed to the bending unit.

15. The device of claim 6, wherein the chassis base comprises a bending unit on an edge thereof, the electronic devices being arranged to correspond to the bending unit, and the supporting members being affixed to the bending unit.

16. The device of claim 7, wherein the chassis base comprises a bending unit on an edge thereof, the electronic devices being arranged to correspond to the bending unit, and the supporting members being affixed to the bending unit.

17. The device of claim 8, wherein the chassis base comprises a bending unit on an edge thereof, the electronic devices being arranged to correspond to the bending unit, and the supporting members being affixed to the bending unit.

18. The device of claim 9, wherein the chassis base comprises a bending unit on an edge thereof, the electronic devices being arranged to correspond to the bending unit, and the supporting members being affixed to the bending unit.
